(19) United States
(12) Patent Application Publication
(10) Pub. No.: US 2016/0144494 A1
(43) Pub. Date: May 26, 2016

(54) POCKET FORMER REMOVAL TOOL

(71) Applicant: Felix SORKIN, Stafford, TX (US)

(72) Inventor: Felix SORKIN, Stafford, TX (US)

(21) Appl. No.: 14/944,422

(22) Filed: Nov. 18, 2015

Related U.S. Application Data
(60) Provisional application No. 62/082,239, filed on Nov. 20, 2014.

(51) Int. Cl. B25B 33/00; E04G 21/12

(52) U.S. Cl. CPC B25B 33/00; E04G 21/12

(57) ABSTRACT

A pocket former removal tool is disclosed. The pocket former removal tool includes a body, the body having a fulcrum, a first end and a second end. The pocket former removal tool further includes tines attached to the second end of the body.

### CROSS-REFERENCE TO RELATED APPLICATIONS

This application is a nonprovisional application which claims priority from U.S. provisional application No. 62/082,239, filed Nov. 20, 2014.

### TECHNICAL FIELD/FIELD OF THE DISCLOSURE

The present disclosure relates to tools for use with post-tensioned concrete forming equipment.

### BACKGROUND OF THE DISCLOSURE

Many structures are built using concrete, including, for instance, buildings, parking structures, apartments, condominiums, hotels, mixed-use buildings, casinos, hospitals, medical buildings, government buildings, research/academic institutions, industrial, malls, bridges, pavement, tanks, reservoirs, silos, foundations, sports courts, and other structures.

Prestressed concrete is structural concrete in which internal stresses are introduced to reduce potential tensile stresses in the concrete resulting from applied loads; this can be accomplished by two methods—post-tensioned prestressing and pre-tensioned prestressing. In a post-tensioned prestressing, the prestressing member is tensioned after a concrete member has attained a specified strength. In post-tensioning applications, the prestressing assembly, commonly known as a tendon, may include for example and without limitation, anchorages, the prestressing member, and sheathes or ducts. For the purposes of this disclosure, the prestressing member will be referred to as a “cable”, although one having ordinary skill in the art with the benefit of this disclosure will understand that the prestressing member could be any suitable material exhibiting tensile strength which can be elongated including, for example and without limitation, reinforcing steel, single or multi strand cable. One having ordinary skill in the art with the benefit of this disclosure will likewise understand that the prestressing member may be formed from a metal or composite without deviating from the scope of this disclosure. The tendon generally includes an anchorage at each end. The cable is generally fixedly coupled to a fixed anchorage positioned at one end of the tendon, the so-called “fixed-end”, and is adapted to be stressed at the other anchor, the “stressing-end” of the tendon.

In order to allow access to the stressing-end of the tendon once the concrete member is poured, a pocket former may be utilized to, for example, prevent concrete from filling in the area between the stressing-end anchor and the concrete form. Once the concrete has sufficiently hardened and the form is removed, the pocket former is removed from the concrete member. Generally, pocket formers are frustoconical in shape to, for example, allow for easier removal from the concrete member. However, removal of the pocket formers, especially when utilizing tools such as screwdrivers, may damage the pocket former, preventing it from being reused in another concrete member.

### SUMMARY

The present disclosure provides a pocket former removal tool. The pocket former removal tool includes a body, the body having a fulcrum, a first end and a second end. The pocket former removal tool further includes tines attached to the second end of the body.

The present disclosure further provides a method for removing a pocket former from a concrete member. The concrete member has a surface. The pocket former has a pocket former extension. The concrete member and the pocket former have a connection. The method includes supplying a pocket former removal tool. The pocket former removal tool includes a body, the body having a fulcrum, a first end and a second end. The pocket former removal tool further includes tines attached to the second end of the body, and a handle, the handle attached to the first end of the body. The method also includes positioning the pocket former removal tool such that the fulcrum is in contact with the concrete member and the tines are engaged with the pocket former extension, and applying a downward force to the handle to create an upward force on the pocket former.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of a pocket former removal tool consistent with certain embodiments of the present disclosure.

FIG. 2 depicts a side view of the pocket former removal tool of FIG. 1.

FIGS. 3A, 3B depict a pocket former removal tool consistent with embodiments of the present disclosure.

FIG. 4 depicts a side view of a pocket former removal tool consistent with embodiments of the present disclosure.

FIG. 5 depicts a side view of a pocket former removal tool consistent with embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

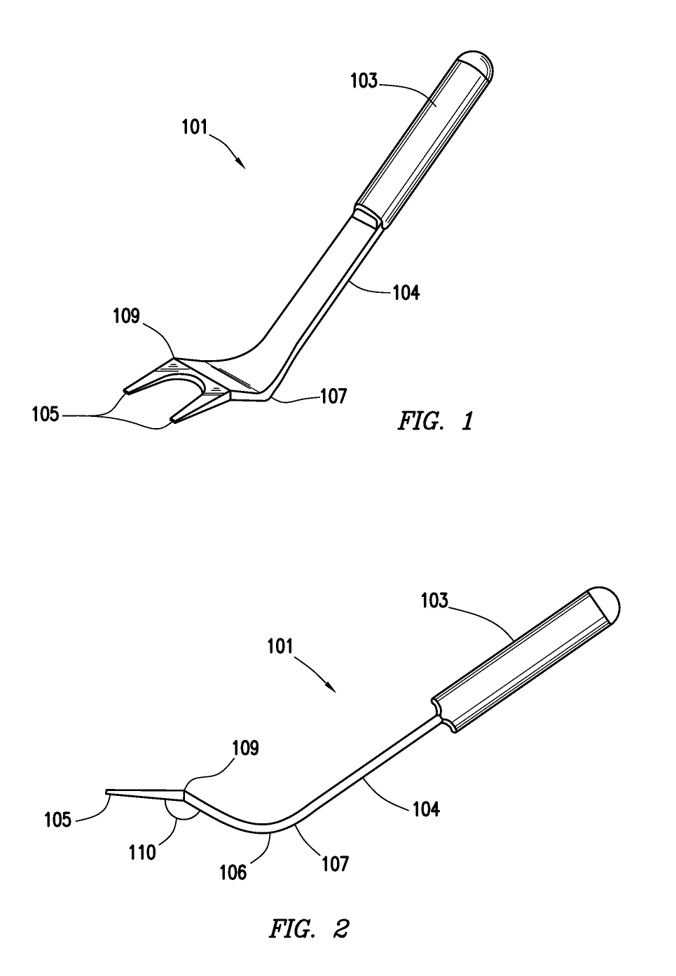

In some embodiments of the present disclosure, pocket former removal tool 101 may be adapted to remove a pocket former from a concrete member. As depicted in FIGS. 1, 2, 4, and 5, pocket former removal tool 101 may include handle 103, body 104, and tines 105. Body 104 of pocket former removal tool 101 may be formed from a material resilient enough to be used as discussed below, including, for example and without limitation, steel, cast iron, or a polymer. In some embodiments, pocket former removal tool 101 may be formed by, for example and without limitation, stamping, casting, forging, or molding.

In some embodiments, as depicted in FIG. 1, pocket former removal tool 101 may include handle 103 attached to a first end of body 104. Handle 103 may assist a user seeking to remove the pocket former to grip pocket former removal tool 101. In some embodiments, handle 103 may be formed integrally with body 104. In some embodiments, handle 103 may be attached to body 104, such as by welding or suitable affixing method recognizable to one of ordinary skill in the art with the benefit of this disclosure. In some embodiments, handle 103 may be formed from a polymer and molded to body 104.

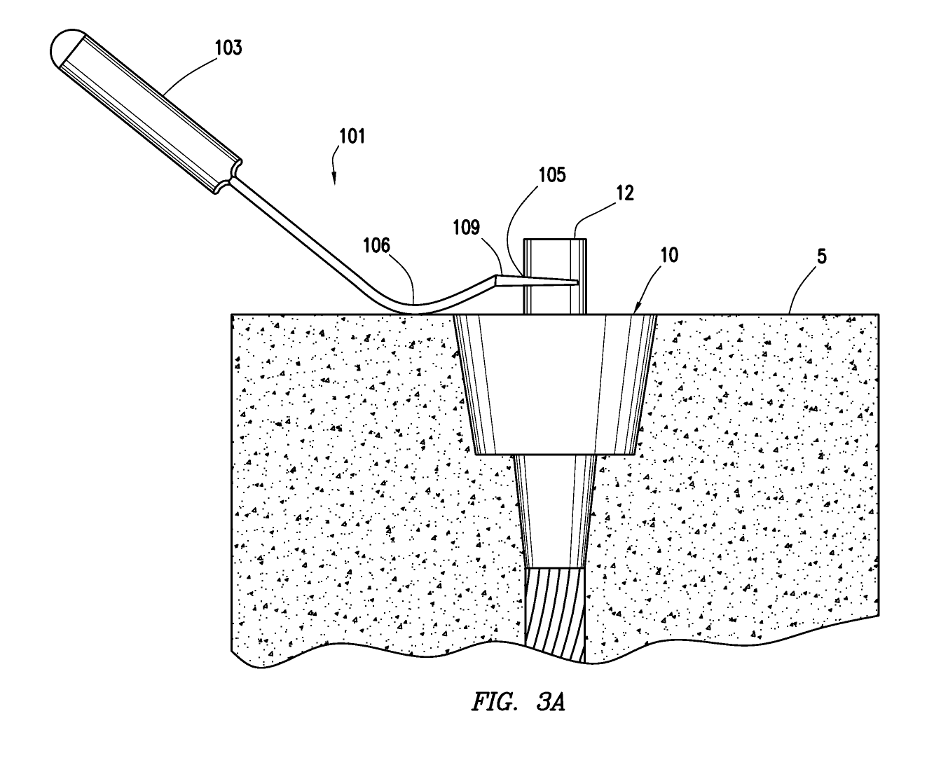

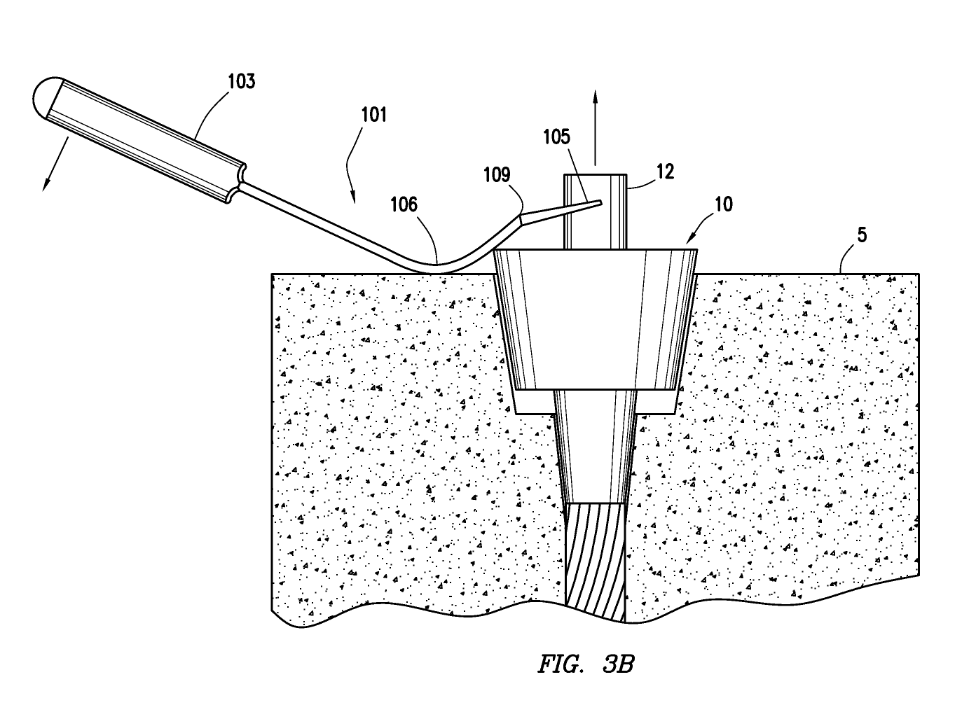

In some embodiments, pocket former removal tool 101 may include tines 105 attached to a second end of body 104. In certain embodiments, tines 105 may be generally flat and tapered. Tines 105 may be used to engage pocket former 10, as depicted in FIGS. 3A, 3B. In some embodiments, tines 105 may touch opposite sides of pocket former extension 12 when engaging pocket former 10. In some embodiments, pocket former extension 12 may include one or more locking features (not shown) including, for example and without limitation, a lip, bumps, detents, grooves, or slots adapted to allow tines 105 to engage pocket former extension 12 and apply an upward force, i.e., away from concrete member 5, thereon.

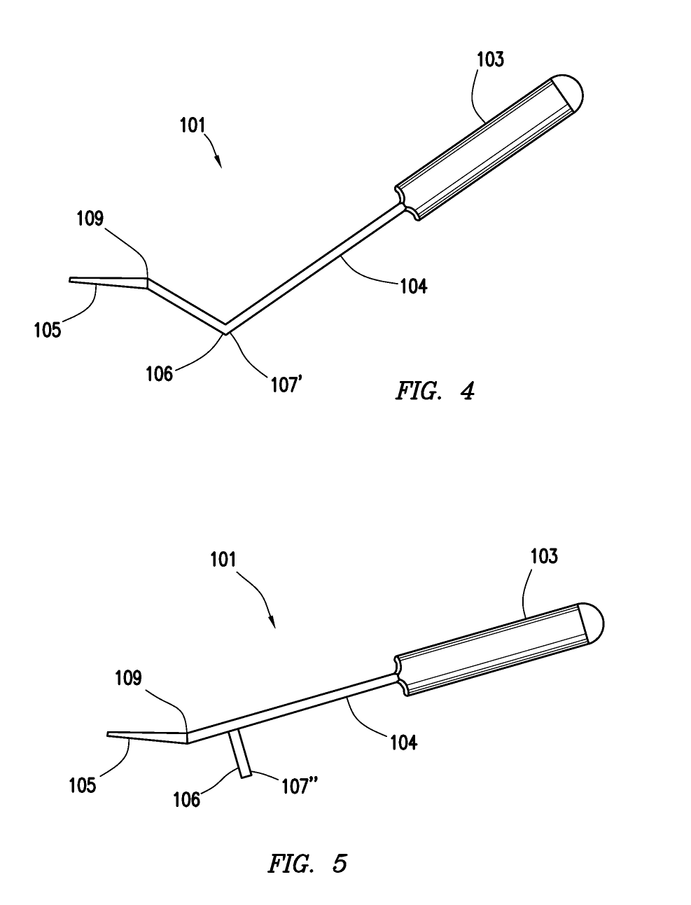

In the embodiments depicted in FIGS. 1, 2, 4, and 5, body 104 includes fulcrum 106. As depicted in FIGS. 1 and 2, fulcrum 106 is curved body piece 107. In other embodiments, fulcrum 106 is angled body piece 107′, as depicted in FIG. 4. In still other embodiments, fulcrum 106 is pivot extension 107″ as depicted in FIG. 5. One having ordinary skill in the art with the benefit of this disclosure will understand that any fulcrum 106 may be used with pocket former removal tool 101 and that the above examples of fulcrum 106 are merely exemplary.

In some embodiments, pocket former removal tool 101 may be used as a lever to remove pocket former 10 from concrete member 5. Fulcrum 106 contacts concrete member 5 between handle 103 and tines 105 when engaged with pocket former 10. Fulcrum 106, when in contact with concrete member 5, allows a downward force, i.e., towards concrete member 5, applied to handle 103 to create a resultant upward force on pocket former 10. By locating fulcrum 106 closer to tines 105 than handle 103, that is closer to the second end of the body than the first end of the body, the resultant upward force on pocket former 10 may be greater than the downward force applied to handle 103. In some embodiments, tines 105 may extend at obtuse angle 110 relative to body 104. For example and without limitation, as depicted in FIG. 3A, tines 105 may include tine bend 109. Tine bend 109 positions tines 105 such that when pocket former removal tool is engaged with pocket former 10, tines 105 extend generally parallel to the surface of concrete member 5. Tine bend 109 may, for example and without limitation, allow tines 105 to engage any locking features included on pocket former extension 12 when pocket former removal tool 101 is engaged with pocket former 10.

In some embodiments, body curve 107 and tines 105 are configured such that, as depicted in FIG. 3B, when pocket former 10 is removed a desired distance from concrete member 5, pocket former 10 contacts pocket former removal tool 101. This contact may, for example and without limitation, slow or prevent further motion of pocket former removal tool 101 towards concrete member 5. One having ordinary skill in the art with the benefit of this disclosure will understand that upon breaking the connection between concrete member 5 and pocket former 10, the resistance to pressure on handle 103 may reduce significantly, which may cause a rapid acceleration of handle 103 (and possibly the hand of a user) towards concrete member 5. In some embodiments, the contact between pocket former 10 and pocket former removal tool 101 may reduce accidental contact of handle 103 with concrete member 5. In some embodiments, handle 103 may include one or more safety features (not shown), such as, for example and without limitation, a handguard.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A pocket former removal tool comprising:
a body, the body having a fulcrum, a first end and a second end; and
tines attached to the second end of the body.

2. The pocket former of claim 1, wherein the body is comprised of steel, cast iron, or a polymer.

3. The pocket former removal tool of claim 1, wherein the pocket former removal tool is formed through stamping, casting, forging, or molding.

4. The pocket former removal tool of claim 1 further comprising a handle, the handle attached to the first end of the body.

5. The pocket former removal tool of claim 1, wherein the tines are flat.

6. The pocket former removal tool of claim 5, wherein the tines are tapered.

7. The pocket former removal tool of claim 1, wherein the fulcrum is a curved body piece, angled body piece, pivot extension, or a combination thereof.

8. The pocket former removal tool of claim 1, wherein the tines extend at an obtuse angle relative to the body.

9. The pocket former removal tool of claim 1, wherein the tines further comprise a tine bend.

10. The pocket former removal tool of claim 1, wherein the fulcrum is closer to the second end of the body than the first end of the body.

11. A method for removing a pocket former from a concrete member, the concrete member having a surface, the pocket former having a pocket former extension, the concrete member and the pocket former having a connection, the method comprising:
supplying a pocket former removal tool, the pocket former removal tool comprising:
a body, the body having a fulcrum, a first end and a second end;
tines attached to the second end of the body; and
a handle, the handle attached to the first end of the body;
positioning the pocket former removal tool such that the fulcrum is in contact with the concrete member and the tines are engaged with the pocket former extension; and
applying a downward force to the handle to create an upward force on the pocket former.

12. The method of claim 11, wherein the pocket former extension further comprises a locking feature, the method further comprising:
engaging the tines with the locking feature.

13. The method of claim 11, the tines further including a tine bend, the method further comprising:
positioning the tines such that the tines extend generally parallel to the surface of the concrete member

14. The method of claim 11 further comprising breaking the connection between the concrete member and the pocket former.

15. The method of claim 11, wherein the tines are flat.

16. The method of claim 15, wherein the tines are tapered.

17. The method of claim 11, wherein the fulcrum is a curved body piece, angled body piece, pivot extension, or a combination thereof.

18. The method of claim 11, wherein the tines extend at an obtuse angle relative to the body.

19. The method of claim 11, wherein the fulcrum is closer to the second end of the body than the first end of the body.

20. The method of claim 11, wherein the body is comprised of steel, cast iron, or a polymer.
